(19) United States
(12) Patent Application Publication
(10) Pub. No.: US 2009/0326158 A1
(43) Pub. Date: Dec. 31, 2009

(54) PROPYLENE BLOCK COPOLYMER

(75) Inventor: Yasuki Fujiwara, Chiba (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/514,479

(22) PCT Filed: Dec. 14, 2007
(86) PCT No.: PCT/JP2007/074599

§ 371 Date: May 28, 2009

(30) Foreign Application Priority Data
Dec. 15, 2006 (JP) 2006-338997

(51) Int. Cl. C08F 10/06; C08L 53/00

(52) U.S. Cl. 525/247; 525/323

(57) ABSTRACT

A propylene block copolymer satisfying the following requirements, which is obtained by producing in the step 1 a propylene polymer component (1), producing in the step 2 a propylene copolymer component (2) in the presence of the component (1), and producing in the step 3 an ethylene copolymer component (3) in the presence of the components (1) and (2):
the component (1) has a melting temperature of 155° C. or higher;
the component (2) contains 40 to 50% by mol of ethylene, and has an intrinsic viscosity of 2.0 to 8.0 dl/g;
the component (3) contains 45 to 70% by mol of ethylene, and has an intrinsic viscosity of 3.0 to 8.0 dl/g, provided that the ethylene content is larger than the ethylene content in the propylene polymer component (2);
a ratio by weight of the component (2) to the component (3) is 1/10 to 1/1;
the propylene block copolymer has a glass transition temperature of −55.0° C. or lower; and
dispersed particles contained in an injection molded article of the block copolymer have a volume-average particle diameter of 1.0 μm or less, provided that the above particles have a round shape in their cross-section.

### TECHNICAL FIELD

The present invention relates to a propylene block copolymer. For more detail, the present invention relates to a propylene block copolymer produced according to multistep polymerization.

### BACKGROUND ART

In recent years, a polypropylene resin has been enjoying a remarkably increasing demand due to its excellent physical properties. A crystalline propylene polymer is excellent in its stiffness and heat stability. However, it has a defect of brittleness at low temperature. Therefore, for example, there is proposed a propylene copolymer produced by multistep polymerization, which copolymer contains a propylene polymer and a low crystalline or non-crystalline copolymer component included in the propylene polymer, the copolymer component being a copolymer of propylene with an olefin other than propylene, such as ethylene. Such a propylene block copolymer is excellent in its property such as stiffness and impact resistance, and is widely used for molded articles such as automobile interior or exterior parts, electrical parts and cases.

A production process of a propylene block copolymer according to a multistep polymerization method comprises generally the first polymerization step of producing a first propylene polymer component, and the second polymerization step of producing a second propylene polymer component in the presence of the first propylene polymer component.

For example, JP 2003-327642A discloses a propylene-ethylene block copolymer obtained according to multistep polymerization. As the propylene-ethylene block copolymer, this patent document uses a propylene-ethylene block copolymer containing 60 to 85% by weight of a crystalline polypropylene part and 15 to 40% by weigh of a propylene-ethylene random copolymer part, and having a melt flow rate (MFR) of 5 to 120 g/10 minutes, wherein the propylene-ethylene random copolymer part contains a propylene-ethylene random copolymer component having an intrinsic viscosity of 1.5 dl/g to less than 4 dl/g, and having an ethylene content of 20% by weight to less than 50% by weight, and a propylene-ethylene random copolymer component having an intrinsic viscosity of 0.5 dl/g to less than 3 dl/g, and having an ethylene content of 50 to 80% by weight. This patent document discloses that there are obtained a propylene-ethylene block copolymer and its molded article excellent in its stiffness, hardness and moldability, and in a balance between toughness and low temperature impact resistance.

Also, WO 95/27741 discloses a propylene polymer composition obtained according to multistep polymerization using a metallocene catalyst. As the propylene polymer composition, this patent document uses a propylene polymer composition containing 20 to 90% by weight of a propylene (co) polymer (a), 5 to 75% by weight of a propylene.olefin copolymer (b), and 5 to 75% by weight of an ethylene.olefin copolymer (c), and having a melt flow rate of 0.01 to 500 g/10 minutes measured at 230° C. under a load of 2.16 kg, which propylene polymer composition is produced according to a multistep polymerization process comprising the step (a) of producing the propylene (co)polymer (a) in the presence of a transition metal compound (A) containing a ligand of cyclopentadienyl structure, and a compound (B) activating the above transition metal compound (A), the step (b) of producing the propylene.olefin copolymer (b), and the step (c) of producing the ethylene.olefin copolymer (c), wherein the steps (a), (b) and (c) are carried out in any order, and the second and third polymerization steps are carried out respectively, in the presence of the polymers formed in the former steps. This patent document discloses that there is obtained a propylene polymer composition excellent in its balance among stiffness, heat resistance and impact resistance.

Further, JP 2003-147035A discloses a propylene block copolymer obtained by polymerizing with a metallocene catalyst. As the propylene copolymer, this patent document uses a propylene copolymer satisfying the following (1) to (6): (1) a melt flow rate of 0.1 to 150 g/10 minutes, (2) insoluble in o-dichlorobenzene at 100° C., and soluble in o-dichlorobenzene at 140° C., (3) an EP content of 5 to 50% by weight, (4) an ethylene content in the EP of 10 to 90% by weight, (5) the ethylene content (G) in the EP and an ethylene content (E) in a non-crystalline component in the EP satisfy the formula (I), G≧E≧−4.5×10−3×G2+1.3×G−7.0 (I), and (6) a melting temperature of 157° C. or higher. This patent document discloses that there is obtained a propylene copolymer excellent in its balance between stiffness and impact resistance, and in its heat resistance, and low in its gloss.

However, regarding even the propylene block copolymers disclosed in the above patent documents, it has been desired to further improve their balance between stiffness and impact resistance, or between stiffness and low temperature impact resistance. In view of the above circumstances, an object of the present invention is to provide a propylene block copolymer capable of molding an article excellent in its balance between stiffness and impact resistance, or between stiffness and low temperature impact resistance.

### DISCLOSURE OF INVENTION

From one point of view, the present invention is a propylene block copolymer satisfying the following requirements (I) to (VI), which is obtained according to a process comprising the first step of producing a propylene polymer component (1), the second step of producing a propylene copolymer component (2) in the presence of the component (1), and the third step of producing an ethylene copolymer component (3) in the presence of the components (1) and (2);

(I) the propylene polymer component (1) has a meting temperature of 155° C. or higher measured according to DSC;

(II) the propylene copolymer component (2) contains ethylene in an amount of 40 to 50% by mol measured according to a ¹³C-NMR spectrum, and has an intrinsic viscosity of 2.0 to 8.0 dl/g measured at 135° C. in TETRALINE;

(III) the ethylene copolymer component (3) contains ethylene in an amount of 45 to 70% by mol measured according to a ¹³C-NMR spectrum, and has an intrinsic viscosity of 3.0 to 8.0 dl/g measured at 135° C. in TETRALINE, provided that said ethylene content is larger than the ethylene content in the propylene copolymer component (2);

(IV) a ratio by weight of the propylene copolymer component (2) to the ethylene copolymer component (3) is 1/10 to 1/1;

(V) the propylene block copolymer has a glass transition temperature of −55.0° C. or lower measured according to DSC; and

(VI) dispersed particles comprising the components (2) and (3) have a volume-average particle diameter of 1.0 μm or less, measured by observing a central part of a cross-section of an article prepared by injection-molding the above propylene block copolymer, provided that the above particles have a round shape in their cross-section.

### BEST MODE FOR CARRYING OUT THE INVENTION

The propylene block copolymer of the present invention contains the propylene polymer component (1) produced in the first step, the propylene copolymer component (2) produced in the second step in the presence of the component (1), and the ethylene copolymer component (3) produced in the third step in the presence of the components (1) and (2).

The propylene polymer component (1) in the propylene block copolymer of the present invention has a meting temperature of 155° C. or higher, and preferably 158 to 170° C. measured according to differential scanning calorimetry (referred to as DSC hereinafter). When the melting temperature is lower than 155° C., the propylene block copolymer of the present invention may be low in its stiffness, heat resistance or hardness.

From a viewpoint of stiffness, heat resistance or hardness, the component (1) is preferably a propylene homopolymer, and further preferably a propylene homopolymer having an isotactic pentad fraction of 0.95 or more measured according to a ¹³C nuclear magnetic resonance (¹³C-NMR) spectrum. The isotactic pentad fraction is an isotactic chain of a pentad unit in a polypropylene molecular chain measured according to ¹³C-NMR, in other words, a fraction of propylene monomer units existing in the center of a chain formed by continuous meso-bonding of five propylene monomer units, the method being disclosed in Macromolecules, 6, 925 (1973) by A. Zambelli et al., wherein NMR absorption peaks are assigned according to Macromolecules, 8, 687 (1975). Specifically, the isotactic pentad fraction is measured as an area fraction of a mmmmmm peak in a total absorption peak in a methyl-carbon region of a ¹³C-NMR spectrum. CRM No. M19-14 Polypropylene PP/MWD/2, which is the NPL reference material of NATIONAL PHYSICAL LABORATORY (England), is measured according to this measurement method to have an isotactic pentad fraction of 0.944.

The propylene polymer component having the above characteristics is produced using a highly regular polymerization catalyst comprising a solid titanium catalyst component known in the art, an organometallic compound catalyst component, and an optional electron donor, or using a highly regular polymerization catalyst comprising a metallocene complex known in the art, an organoaluminum compound, and an optional compound reacting with the metallocene complex to form a stable anion.

Examples of the polymerization method for the above propylene polymer component are a slurry polymerization method using an inert hydrocarbon solvent such as propane, butane, isobutene, pentane, hexane, heptane and octane; a solution polymerization method using an inert hydrocarbon solvent such as those mentioned above; a bulk polymerization method using an olefin as a medium, the olefin being liquid at a polymerization temperature; and a gas phase polymerization method.

The polymerization is carried out at usually 20 to 100° C. and particularly preferably 40 to 90° C. Its polymerization pressure is preferably 0.1 to 6 MPa. Its polymerization time is generally determined suitably according to a type of a target polymer and a reaction apparatus, and is usually 1 minute to 20 hours. Also, in order to regulate a molecular weight of the propylene polymer component, a chain-transfer agent such as hydrogen may be added to a polymerization system.

The propylene copolymer component (2) in the propylene block copolymer of the present invention is an ethylene-propylene copolymer, which contains ethylene in an amount of 40 to 50% by mol, and preferably 45 to 50% by mol, measured according to a ¹³C-NMR spectrum, and has an intrinsic viscosity of 2.0 to 8.0 dl/g, and preferably 3.0 to 7.0 dl/g measured at 135° C. in TETRALINE. When the ethylene content and the intrinsic viscosity are outside of the above range, the propylene block copolymer of the present invention may be low in its mechanical property balance such as stiffness and impact resistance.

The propylene copolymer component having the above characteristics is produced using a polymerization catalyst comprising a solid titanium catalyst component known in the art, an organometallic compound catalyst component, and an optional electron donor, or using a polymerization catalyst comprising a metallocene complex known in the art, an organoaluminum compound, and an optional compound reacting with the metallocene complex to form a stable anion. Among them, a polymerization catalysts comprising a metallocene complex is preferable.

Examples of the production method for the above propylene copolymer component are a slurry polymerization method using an inert hydrocarbon solvent such as propane, butane, isobutene, pentane, hexane, heptane and octane; a solution polymerization method using an inert hydrocarbon solvent such as those mentioned above; a bulk polymerization method using an olefin as a medium, the olefin being liquid at a polymerization temperature; and a gas phase polymerization method.

The polymerization is carried out at usually 20 to 100° C. and particularly preferably 40 to 90° C. Its polymerization pressure is preferably 1.0 to 6 MPa, and more preferably 2.0 to 5.0 MPa. When the polymerization pressure is 1.0 MPa or lower, the propylene copolymer component may be low in its intrinsic viscosity ([η]). Its polymerization time is generally determined suitably according to a type of a target polymer and a reaction apparatus, and is usually 1 minute to 20 hours. Also, in order to regulate a molecular weight of the propylene copolymer component, a chain-transfer agent such as hydrogen may be added to a polymerization system.

The ethylene copolymer component (3) in the propylene block copolymer of the present invention contains ethylene in an amount of 45 to 70% by mol, and preferably 55 to 65% by mol measured according to a ¹³C-NMR spectrum, provided that the ethylene content in the component (3) is smaller than the ethylene content in the component (2), and has an intrinsic viscosity of 3.0 to 8.0 dl/g, preferably 4.0 to 6.0 dl/g, measured at 135° C. in TETRALINE. When the ethylene content and the intrinsic viscosity are outside of the above range, the propylene block copolymer of the present invention may be low in its mechanical property balance such as stiffness and impact resistance.

The ethylene copolymer component having the above characteristics is produced using a polymerization catalyst comprising a solid titanium catalyst component known in the art, an organometallic compound catalyst component, and an optional electron donor, or using a polymerization catalyst comprising a metallocene complex known in the art, an organoaluminum compound, and an optional compound reacting with the metallocene complex to form a stable anion. Among them, a polymerization catalysts comprising a metallocene complex is preferable.

Examples of the production method for the above ethylene copolymer component are a slurry polymerization method using an inert hydrocarbon solvent such as propane, butane, isobutene, pentane, hexane, heptane and octane; a solution polymerization method using an inert hydrocarbon solvent such as those mentioned above; a bulk polymerization method using an olefin as a medium, the olefin being liquid at a polymerization temperature; and a gas phase polymerization method.

The polymerization is carried out at usually 20 to 100° C. and particularly preferably 40 to 90° C. Its polymerization pressure is preferably 1.0 to 6 MPa, and more preferably 2.0 to 5.0 MPa. When the polymerization pressure is 1.0 MPa or lower, the ethylene copolymer component may be low in its intrinsic viscosity ([η]). Its polymerization time is generally determined suitably according to a type of a target polymer and a reaction apparatus, and is usually 1 minute to 20 hours. Also, in order to regulate a molecular weight of the propylene copolymer component, a chain-transfer agent such as hydrogen may be added to a polymerization system.

A ratio by weight of the propylene copolymer component (2) to the ethylene copolymer component (3) in the propylene block copolymer of the present invention is 1/10 to 1/1, and preferably 1/8 to 1/1. When the ratio by weight of the component (2) to the component (3) is outside of the above range, the propylene block copolymer of the present invention may be low in its mechanical property balance and molding processability.

The propylene block copolymer of the present invention contains the propylene copolymer component (2) and the ethylene copolymer component (3) in their total amount of preferably 10 to 50% by weight, the total of the propylene block copolymer of the present invention being 100% by weight. When their total amount is less than 10% by weight, the propylene block copolymer of the present invention may be insufficient in its impact resistance, and when their total amount is more than 50% by weight, the propylene block copolymer of the present invention may be insufficient in its stiffness.

The propylene block copolymer of the present invention has a glass transition temperature (Tg) of −55.0° C. or lower, and preferably −57° C. or lower measured according to differential scanning calorimetry (DSC). When Tg is higher than −55° C., the propylene block copolymer of the present invention may be low in its impact resistance, particularly in its low-temperature impact resistance.

Dispersed particles comprising the components (2) and (3) have a volume-average particle diameter (Dv) of 1.0 μm or less, measured by observing a central part of a cross-section of an article prepared by injection-molding the propylene block copolymer of the present invention, provided that the above particles have a round shape in their cross-section. When Dv is more than 1.0 μm, the propylene block copolymer of the present invention may be low in its mechanical property balance, such as a balance between stiffness and impact resistance.

The propylene block copolymer of the present invention can be synthesized using a catalyst system containing a combination as an essential component of (A) a cyclopentadienyl ring-containing transition metal compound of the groups 4 to 6 of the periodic table, (B) modified particles and (C) an organoaluminum compound.

The above cyclopentadienyl ring-containing transition metal compound of the groups 4 to 6 of the periodic table (A) is particularly preferably a compound represented by the following general formula [1]:

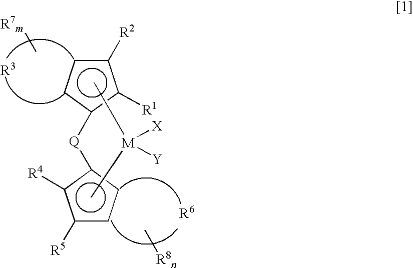

wherein R¹, R², R⁴, and R⁵ are independently of one another a hydrogen atom, a hydrocarbyl group having 1 to 6 carbon atoms, a silicon-containing hydrocarbyl group having 1 to 7 carbon atoms, or a halogenated hydrocarbyl group having 1 to 6 carbon atoms; R³ and R⁶ are independently of each other a saturated or unsaturated divalent hydrocarbyl group having 3 to 10 carbon atoms, provided that at least one of R³ and R⁶ have 5 to 8 carbon atoms; R⁷ and R⁸ are independently of each other an aryl group having 8 to 20 carbon atoms, or a halogen-substituted or halogenated hydrocarbon-substituted aryl group having 8 to 20; m and n are independently of each other an integer of 0 to 20, provided that m and n are not zero at the same time, and when m or n is 2 or more, plural R⁷s or plural R⁸s may be linked to one another at any position to form a new ring structure; Q is a divalent hydrocarbyl group having 1 to 20 carbon atoms, a silylene group optionally having a C₁₋₂₀ hydrocarbyl group, an oligosilylene group, or a gelmylene group; X and Y are independently of each other a hydrogen atom, a halogen atom, a hydrocarbyl group having 1 to 20 carbon atoms, a silicon-containing hydrocarbyl group having 1 to 20 carbon atoms, a halogenated hydrocarbyl group having 1 to 20 carbon atoms, an oxygen-containing hydrocarbyl group having 1 to 20 carbon atoms, an amino group, or a nitrogen-containing hydrocarbyl group having 1 to 20 carbon atoms; and M is a transition metal of the groups 4 to 6 of the periodic table.

The transition metal compound represented by the general formula [1] means both compound (a) and (b), the compound (a) being a compound whose five-membered ligand having the substituents R¹, R² and R³ and five-membered ligand having the substituents R⁴, R⁵ and R⁶ are asymmetrical, regarding the plane containing M, X and Y, from a viewpoint of a relative position through Q, and the compound (b) being a compound whose five-membered ligand having the substituents R¹, R² and R³ and five-membered ligand having the substituents R⁴, R⁵ and R⁶ are symmetrical, regarding the plane containing M, X and Y, from a viewpoint of a relative position through Q. However, in order to produce a propylene polymer having a high molecular weight and a high melting temperature, it is preferable to use the above compound (a), namely, a compound whose two five-membered ligands do not have a relation of a mirror image with an entity, regarding the plane containing M, X and Y, wherein those two five-membered ligands face to each other interleaving this plane.

Among transition metal compounds represented by the general formula [1], preferably used are compounds represented by the following general formula [2]:

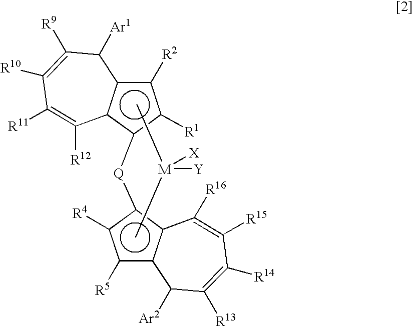

wherein R¹, R², R⁴, R⁵, M, Q, X and Y are the same as those defined above, respectively; and R⁹, R¹⁰, R¹¹, R¹², R¹³, R¹⁴, R¹⁵ and R¹⁶ are independently of one another a hydrogen atom, a hydrocarbyl group having 1 to 20 carbon atoms, or a halogenated hydrocarbyl group having 1 to 20 carbon atoms. Each of R⁹, R¹⁰, R¹¹, R¹², R¹³, R¹⁴, R¹⁵ and R¹⁶ is preferably a hydrogen atom.

Ar¹ and Ar² are independently of each other an aryl group having 8 to 20 carbon atoms, or a halogen-substituted or halogenated hydrocarbon-substituted aryl group having 8 to 20. Specific examples of the hydrocarbyl group having 8 to 20 carbon atoms, or a halogenated hydrocarbyl group having 8 to 20 are those exemplified as R⁷ and R⁸ in the general formula [1]. Ar¹ and Ar² are more preferably, independently of each other, those represented by the following general formula [3]:

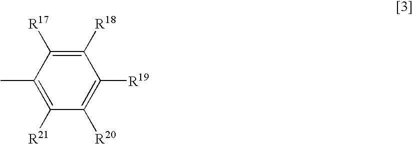

wherein R¹⁷, R¹⁸, R¹⁹, R²⁰ and R²¹ are a hydrogen atom, a halogen atom, a hydrocarbyl group having 1 to 14 carbon atoms, or a halogenated hydrocarbyl group having 1 to 14 carbon atoms; one or more of R¹⁷, R¹⁸, R¹⁹, R²⁰ and 21 are a hydrocarbyl group having 2 to 14 carbon atoms, or a halogenated hydrocarbyl group having 2 to 14 carbon atoms; and when plurality of the hydrocarbyl groups or halogenated hydrocarbyl groups exist, they may be linked to one another in any positions to form a ring structure.

Specific examples of the compound represented by the general formula [2] are the followings: dichloro{1,1′-dimethylmethylenebis[2-methyl-4-(4-biphenylyl)-4H-azulenyl]}hafnium, dichloro{1,1′-dimethylsilylenebis[2-methyl-4-(2-fluoro-4-biphenylyl)-4H-azulenyl]}hafnium, dichloro{1,1′-dimethylsilylenebis[2-ethyl-4-(2-fluoro-4-biphenylyl)-4H-azulenyl]}hafnium, dichloro{1,1′-dimethylsilylenebis[2-methyl-4-(2,6-difluoro-4-biphenylyl)-4H-azulenyl]}hafnium, dichloro{1,1′-dimethylsilylenebis[2-methyl-4-(2′,6′-dimethyl-4-biphenylyl)-4H-azulenyl]}hafnium, dichloro{1,1′-dimethylsilylenebis[2-ethyl-4-(2-fluoro-3-biphenylyl)-4H-azulenyl]}hafnium, dichloro{1,1′-dimethylsilylenebis[2-methyl-4-(1-naphthyl)-4H-azulenyl]}hafnium, dichloro{1,1′-dimethylsilylenebis[2-ethyl-4-(1-naphthyl)-4H-azulenyl]}hafnium, dichloro{1,1′-dimethylsilylenebis[2-methyl-4-(4-fluoro-1-naphthyl)-4H-azulenyl]}hafnium, dichloro{1,1′-dimethylsilylenebis[2-methyl-4-(4-fluoro-2-naphthyl)-4H-azulenyl]}hafnium, dichloro{1,1′-dimethylsilylenebis[2-methyl-4-(4-t-butylphenyl)-4H-azulenyl]}hafnium, and dichloro{dimethylsilylene-1-[2-methyl-4-(4-biphenylyl)-4H-azulenyl]-1-[2-methyl-4-(4-biphenylyl)indenyl]}hafnium.

Further examples are compounds, wherein either one or both of two chlorine atoms corresponding to the X part and the Y part in the general formula [2] in the above-exemplified compounds are changed to a hydrogen atom, a fluorine atom, a bromine atom, an iodine atom, a methyl group, a phenyl group, a fluorophenyl group, a benzyl group, a methoxy group, a dimethylamino group or a diethylamino group. Still further examples are compounds, wherein the central metal (M) in the above-exemplified compounds is changed to an atom such as a titanium atom, a zirconium atom, a tantalum atom, a niobium atom, a vanadium atom, a tungsten atom, and a molybdenum atom. Among them, preferred are compounds of a transition metal of the group 4 such as a zirconium atom, a titanium atom and a hafnium atom, and particularly preferred are compounds of a transition metal of the group 4 such as a zirconium atom and a hafnium atom.

The modified particles (B) in the present invention are modified particles obtained by contacting, with one another, the following (a), (b), (c) and particles (d) disclosed in JP 2003-105013A or JP 2003-171412A:

(a): a compound represented by the following general formula [4],

M¹L¹ₘ [4],

(b): a compound represented by the following general formula [5],

R¹ₜ₋₁TH [5], and

(c): a compound represented by the following general formula [6],

R²ₜ₋₂TH₂ [6]

wherein M¹ is a typical metal atom of the group 1, 2, 12, 14 or 15 of the periodic table; m is the valence of M¹; L¹ is a hydrogen atom, a halogen atom or a hydrocarbon group, and when plurality of L¹ exist, they are the same as or different from one another; R¹ is an electron-withdrawing group or an electron-withdrawing group-containing group, and when plurality of R¹ exist, they are the same as or different from one another; R² is a hydrocarbon group or a halogenated hydrocarbon group; T is independently of each other an atom of the group 15 or 16 of the periodic table; and t is the valence of T in respective compounds.

M¹ in the above general formula [4] is a typical metal atom of the group 1, 2, 12, 14 or 15 of the periodic table of the elements (revised edition of IUPAC Inorganic Chemistry Nomenclature 1989). M¹ is preferably a magnesium atom, a zinc atom, a tin atom or a bismuth atom, and more preferably a zinc atom. Also, m in the above general formula [1] is the valence of M¹, and for example, when M¹ is a zinc atom, m is 2.

L¹ in the above general formula [4] is a hydrogen atom, a halogen atom or a hydrocarbon group, and when plurality of L¹ exist, they are the same as or different from one another. L¹ is preferably a hydrogen atom, an alkyl group or an aryl group; further preferably a hydrogen atom or an alkyl group; and particularly preferably an alkyl group.

Ts in the general formulas [5] and [6] representing the compounds (b) and (c), respectively, are independently of each other a non-metal atom of the group 15 or 16 in the periodic table of elements (revised edition of IUPAC Inorganic Chemistry Nomenclature 1989). Ts in the general formulas [5] and [6] are the same as or different from each other. Specific examples of the non-metal atom of the group 15 are a nitrogen atom and a phosphorous atom, and specific examples of the non-metal atom of the group 16 are an oxygen atom and a sulfur atom. Ts are preferably independently of each other a nitrogen atom or an oxygen atom, and particularly preferably an oxygen atom. Each t in the above general formulas [5] or [6] is the valence of T. When T is a non-metal atom of the group 15, t is 3, and when T is a non-metal atom of the group 16, t is 2.

R¹ in the above general formula [5] is an electron-withdrawing group or an electron-withdrawing group-containing group, and when plurality of R¹ exist, they are the same as or different from one another. As an index of the electron-withdrawing property, there is known a substituent constant σ of the Hammet's rule. An example of the electron-withdrawing group is a functional group whose substituent constant σ of the Hammet's rule is positive.

R¹ is preferably a halogenated hydrocarbyl group, and more preferably a halogenated alkyl group or a halogenated aryl group. Specific examples are preferably fluoroalkyl groups or fluoroaryl groups, and more preferably a trifluoromethyl group, a 2,2,2-trifluoro-1-trifluoromethylethyl group, a 1,1-bis(trifluoromethyl)-2,2,2-trifluoroethyl group, a 3,5-difluorophenyl group, a 3,4,5-trifluorophenyl group, and pentafluorophenyl group.

R² in the above general formula [5] is preferably a halogenated hydrocarbyl group, and further preferably a fluorinated hydrocarbyl group.

Specific examples of the compound (a) having a zinc atom as M¹ are preferably dialkylzincs, and further preferably dimethylzinc, diethylzinc, dipropylzinc, di-n-butylzinc, di-isobutylzinc and di-n-hexylzinc, and particularly preferably dimethylzinc and diethylzinc.

Specific examples of the compound (b) are preferably bis(trifluoromethyl)amine, bis(pentafluorophenyl)amine, trifluoromethanol, 2,2,2-trifluoro-1-trifluoromethylethanol, 1,1-bis(trifluoromethyl)-2,2,2-trifluoroethanol, 2-fluorophenol, 3-fluorophenol, 4-fluorophenol, 2,6-difluorophenol, 3,5-difluorophenol, 2,4,6-trifluorophenol, 3,4,5-trifluorophenol, pentafluorophenol, 4-(trifluoromethyl)phenol, 2,6-bis(trifluoromethyl)phenol, and 2,4,6-tris(trifluoromethyl)phenol, and more preferably 3,5-difluorophenol, 3,4,5-trifluorophenol, pentafluorophenol, and 1,1-bis(trifluoromethyl)-2,2,2-trifluoroethanol.

The compound (c) is preferably water or pentafluoroaniline.

The particles (d) are preferably substances generally used as a carrier. As the particles (d), porous substances having a uniform particle diameter are preferable, and inorganic or organic polymers are preferably used, and inorganic substances are more preferably used. From a viewpoint of particle diameter distribution of a polymer obtained, a geometric standard deviation of a volume-basis particle diameter distribution of the particles (d) is preferably 2.5 or less, more preferably 2.0 or less, and further preferably 1.7 or less.

As the particles (d), inorganic substances are preferably used. Also, as inorganic peroxides, it is permitted to use modified inorganic oxides obtained by substituting active hydrogen atoms of hydroxyl groups existing on the surface of the inorganic oxides with various kinds of substituents. In this case, a preferable substituent is a silyl group. Specific examples of the modified inorganic oxides are inorganic oxides treated with trialkylchlorosilanes such as trimethylchlorosilane and tert-butyldimethylchlorosilane; triarylchlorosilanes such as triphenylchlorosilane; dialkyldichlorosilanes such as dimethyldichlorosilane; diaryldichlorosilanes such as diphenyldichlorosilane; alkyltrichlorosilanes such as methyltrichlorosilane; aryltrichlorosilanes such as phenyltrichlorosilane; trialkylalkoxysilanes such as trimethylmethoxysilane; triarylalkoxysilanes such as triphenylmethoxysilane; dialkyldialkoxysilanes such as dimethyldimethoxysilane; diaryldialkoxysilanes such as diphenyldimethoxysilane; alkyltrialkoxysilanes such as methyltrimethoxysilane; aryltrialkoxysilanes such as phenyltrimethoxysilane; tetraalkoxysilanes such as tetramethoxysilane; alkyldisilazane such as 1,1,1,3,3,3-hexamethyldisilazane; or tetrachlorosilane.

A contact order in contacting (a), (b), (c) and (d) is preferably:

contacting (a) with (b) to produce a first contact product, then contacting the first contact product with (c) to produce a second contact product, and then contacting the second contact product with (d);

contacting (a) with (b) to produce a first contact product, then contacting the first contact product with (d) to produce a second contact product, and then contacting the second contact product with (c);

contacting (c) with (d) to produce a first contact product, then contacting the first contact product with (a) to produce a second contact product, and then contacting the second contact product with (b); or

contacting (c) with (d) to produce a first contact product, then contacting the first contact product with (b) to produce a second contact product, and then contacting the second contact product with (a).

Those contact treatments are carried out preferably in an atmosphere of an inert gas. Treatment temperature thereof is preferably −80 to 200° C., and treatment time thereof is preferably 10 minutes to 100 hours. Those treatments may use a solvent, or those compounds may be directly treated without a solvent.

As the solvent, there is used generally a solvent, which does not react with respective components contacted in using the solvent, or does not react with a contact product obtained by contacting.

Although the above respective compounds (a), (b) and (c) are not particularly limited in their used amounts, it is preferable that y and z satisfy substantially the following expression (i), provided that a ratio by mol of their used amounts (a):(b):(c)=1:y:z,

|m−y−2z|≦1 (1)

wherein m is the valence of M¹.

In the above expression (i), y is a number of preferably 0.01 to 1.99, more preferably 0.10 to 1.80, further preferably 0.20 to 1.50, and particularly preferably 0.30 to 1.00. Similarly preferable ranges of z in the above expression (i) are determined by m, y and the above expression (i).

In preparing modified particles, typical metal atoms derived from (a) are contained in the particles obtained by contacting (a) with (d) in an amount of preferably 0.1 mmol or more, and more preferably 0.5 to 20 mmol, per 1 g of the obtained particles, and therefore, the amount of (d) used for (a) is suitably determined so as to satisfy those ranges.

After the contact treatments as mentioned above, an additional heating treatment is preferably carried out, in order to further promote the reaction. When heating, it is preferable to use a solvent having a higher boiling point, in order to carry out the reaction at a higher temperature. For that purpose, it is permitted to replace a solvent used in the contact treatment with other solvent having a higher boiling point.

The modified particles resulted from such a contact treatment may contain the starting materials (a), (b), (c) and/or (d) remaining as unreacted materials. However, when applying the modified particles to polymerization generating addition polymer particles, it is preferable to carry out a washing treatment to remove the unreacted materials in advance. A solvent used for that purpose is the same as or different from a solvent used for the above contact treatments.

Further, after those treatments of contacting and washing, it is preferable to distil away the solvent from the product, and dry the product at 80 to 160° C. for 4 to 18 hours.

The organoaluminum compound (C) in the present invention is a compound containing one or more Al-carbon bonds in its molecule. Typical compounds thereof are those represented by the following general formula:

R¹_{w}AlY_{3-w} [7]

wherein R¹ is a hydrocarbyl group having 1 to 20 carbon atoms; Y is a halogen atom, a hydrogen atom or an alkoxy group; and w is a number satisfying 2≦w≦3.

Specific examples of the organoaluminum compound are trialkylaluminums such as triethylaluminum, triisobutylaluminum and trihexylaluminum; dialkylaluminum hydrides such as diethylaluminum hydride, and diisobutylaluminum hydride; dialkylaluminum halides such as diethylaluminum chloride; and mixtures of trialkylaluminums with dialkylaluminum halides such as a mixture of triethylaluminum with diethylaluminum chloride.

Among those organoaluminum compounds, preferred are trialkylaluminums, or mixtures of trialkylaluminums with dialkylaluminum hydrides, and particularly preferred is triethylaluminum, triisobutylaluminum, or a mixture of triethylaluminum with diethylaluminum chloride.

The production process of the propylene block copolymer of the present invention comprises the following steps using the above catalyst:

polymerization step 1 (production of propylene polymer component (1)): step of homopolymerizing propylene to form a homopolypropylene, or copolymerizing propylene with an olefin selected from the group consisting ethylene and α-olefins having 4 to 10 carbon atoms to form the copolymer A, wherein the above homopolypropylene or copolymer A is the propylene polymer component (1), and the above homopolymerization or copolymerization is carried out such that the propylene polymer component (1) has a meting temperature of 155° C. or higher measured according to DSC;

polymerization step 2 (production of propylene copolymer (2)): step of copolymerizing propylene with an olefin selected from the group consisting ethylene and α-olefins having 4 to 10 carbon atoms in the presence of the propylene polymer component (1) obtained in the polymerization step 1, thereby forming the propylene copolymer (2), wherein the above copolymerization is carried out such that the propylene copolymer (2) contains 40 to 50% by mol of ethylene polymerization units, provided that the total units in the copolymer (2) is 100% by mol, and has an intrinsic viscosity of 1.0 to 15 dl/g measured at 135° C. in TETRALINE; and polymerization step 3 (production of ethylene copolymer (3)): step of copolymerizing ethylene with an olefin selected from the group consisting α-olefins having 3 to 10 carbon atoms in the presence of the components (1) and (2) produced in the polymerization steps 1 and 2, thereby forming the ethylene copolymer (3), wherein the above copolymerization is carried out such that the copolymer (2) contains 45 to 70% by mol of ethylene polymerization units, provided that the total units in the copolymer (2) is 100% by mol, has an intrinsic viscosity of 2.5 to 15 dl/g measured at 135° C. in TETRALINE, and a ratio by weight of the propylene copolymer component (2) to the ethylene copolymer component (3) is 1/10 to 1/1.

In the present invention, the above catalyst is used as it is for producing the above block copolymer, which is referred to hereinafter as “main polymerization”. Otherwise, the above catalyst is subjected to a pre-polymerization treatment to obtain a pre-polymerization catalyst, which can also be used for the main polymerization.

The pre-polymerization catalyst is usually produced by polymerizing (pre-polymerizing) a small amount of an olefin in the presence of the above cyclopentadienyl ring-containing transition metal compound (A) of the groups 4 to 6 of the periodic table, the modified particles (B) and the organoaluminum compound (C). A pre-polymerization method is preferably a slurry polymerization with an inert hydrocarbon solvent such as propane, butane, isobutane, pentane, isopentane, hexane, heptane, octane, cyclohexane, benzene and toluene. A part of the solvent or the total thereof can be replaced by a liquid olefin.

Examples of the real polymerization method are (1) a method of polymerizing an olefin in the presence of a catalyst obtaining by contacting the cyclopentadienyl ring-containing transition metal compound (A) of the groups 4 to 6 of the periodic table, the modified particles (B) and the organoaluminum compound (C), with one another, (2) a method of polymerizing an olefin in the presence of the pre-polymerization catalyst, and (3) a method of polymerizing an olefin in the presence of a contact product of the pre-polymerization catalyst, the organoaluminum compound, and an optional electron donor compound, with one another.

Main polymerization temperature is usually −30 to 300° C., preferably 20 to 180° C., and more preferably 50 to 95° C. Main polymerization pressure is usually atmospheric pressure to 10 MPa, preferably 1.0 to 6.0 MPa, and more preferably 2.0 to 5.0 MPa, from an industrial and economical point of view. Its polymerization type may be a batch-wise type or a continuous type. Examples of its polymerization method are a slurry polymerization method with an inert hydrocarbon solvent such as propane, butane, isobutane, pentane, hexane, heptane and octane, a solution polymerization method with those solvents, a bulk polymerization using an olefin, which is liquid at a polymerization temperature, as a medium, and a gas-phase polymerization method. Particularly, the above steps 2 and 3 are preferably carried out according to a gas-phase polymerization method, in order to obtain a polymer excellent in its powder property.

In order to regulate a molecular weight of an olefin polymer obtained, the real polymerization may use a chain-transfer agent such as hydrogen.

### EXAMPLE

The present invention is explained with the following Examples, which are only examples of the present invention, and do not limit the present invention. Physical properties of polymers and compositions used in Examples and Comparative Examples were measured according to the following methods.

(1) Intrinsic Viscosity ([η], Unit: dl/g)

It was obtained according to a method comprising the steps of:

measuring respective reduced viscosities of TETRALINE solutions having concentrations of 0.1, 0.2 and 0.5 g/dl, at 135° C. with an Ubbellohde viscometer; and

calculating an intrinsic viscosity according to a method described in “Kobunshi yoeki, Kobunshi jikkengaku 11” (published by Kyoritsu Shuppan Co. Ltd. in 1982), section 491, namely, by plotting those reduced viscosities for those concentrations, and then extrapolating the concentration to zero.

### (1-1) Intrinsic Viscosity of Propylene Block Copolymer

### (1-1a) Intrinsic Viscosity of Propylene Polymer Component (P): [η]P

The intrinsic viscosity ([η]P) of the propylene polymer produced in the step 1 was obtained according to a procedure comprising the steps of taking the polymer powder out of a polymerization reactor after completion of the step 1, and measuring according to the method mentioned in the above (1).

The intrinsic viscosity ([η]P) of the propylene copolymer component obtained in the step 2, the intrinsic viscosity ([η]EP2) of the ethylene copolymer component obtained in the step 3, and the intrinsic viscosity ([η]EP) of the copolymerization component (hereinafter, referred to as EP) comprising EP1 and EP2 in the finally obtained propylene block copolymer were obtained according the following methods, respectively.

### (1-1b) [η]EP1

The intrinsic viscosity ([η]EP1) of a propylene copolymer component (EP1) produced in the step 2 was obtained according to a procedure comprising the steps of taking a sample out of a polymerization reactor after completion of the step 2, measuring the intrinsic viscosity ([η]T1) of the sample, and obtaining from the following formula using the ratio by weight (x₁) of the propylene copolymer component (EP1) to the total of the propylene block copolymer, wherein the ratio by weight (x₁) was obtained according to the measurement method mentioned in the following (2):

[η]EP1={[η]T1−(1−X₁)[η]P}/X₁

wherein [η]P is the intrinsic viscosity of the propylene homopolymer part; [η]T1 is the intrinsic viscosity of the sample taken out of a polymerization reactor after completion of the step 2; and X₁ is the ratio by weight of the propylene copolymer component (b) to the total of the propylene block copolymer obtained after completion of the step 2.

### (1-1c) [η]EP

The intrinsic viscosity ([η]EP) of the component (EP) containing both the propylene copolymer component (EP1) and the ethylene copolymer component (EP2) in the propylene block copolymer finally obtained after completion of the step 3 was obtained according to the similar manner to that in the above (1-1b):

[η]EP=[η]T2/X₂−(1/X₂−1)[η]P

wherein [η]P is the intrinsic viscosity of the propylene homopolymer part; [η]T2 is the intrinsic viscosity of the finally-obtained total propylene-ethylene block copolymer; and X₂ is the ratio by weight of the total of the propylene copolymer component (EP1) obtained in the step 2, and the ethylene copolymer component (EP2) obtained in the step 3, to the total propylene block copolymer obtained after completion of the step 3.

### (1-1d) Intrinsic Viscosity of Ethylene Copolymer Component (EP 2): [η]EP2

The intrinsic viscosity ([η]EP2) of the ethylene copolymer component (EP2) polymerized in the step 3 was obtained from the intrinsic viscosity ([η]T2) of the propylene block copolymer finally obtained after completion of the step 3, the intrinsic viscosity ([η]EP1) of the propylene copolymer component (EP1) obtained in the step 2, the intrinsic viscosity ([η]P) of the propylene polymer (P) polymerized in the step 1, and the respective ratio by weight:

[η]EP2=([η]EP·X₂−[η]EP1·X_{EP1})/X_{EP2}

wherein X_{EP1} is the ratio by weight of the propylene copolymer component (EP1) to the finally-obtained total propylene block copolymer; X_{EP2} is the ratio by weight of the ethylene copolymer component (EP2) to the finally-obtained total propylene block copolymer; X_{EP1}=(X₁−X₂·X₁)/(1−X₁); and X₂=X_{EP1}+X_{EP2}.
(2) Ratio by weight (X, unit: % by weight) of both propylene copolymer component (EP1) and ethylene copolymer component (EP2) to total propylene block copolymer, and ethylene content (C^{2′}, unit: % by mol) in each of propylene copolymer component (EP1) and ethylene copolymer component (EP2)

They were obtained from a ¹³C-NMR spectrum measured under the following conditions according to descriptions in Macromolecules, 15, 1150-1152 (1982) by Kakugo, et al., wherein a sample for the ¹³C-NMR measurement was prepared by dissolving homogeneously about 200 mg of a propylene-ethylene block copolymer in 3 mL of o-dichlorobenzene using a 10 mm-Φ test tube:

measurement temperature: 135° C.,

pulse repetition time: 4.3 seconds,

flip angle: 45°, and

cumulated number: 2,500.

### (3) Glass Transition Temperature (Tg, Unit: ° C.)

It was measured with a differential scanning calorimeter DSC Q100 manufactured by TA Instruments according to a method comprising the steps of:

melting about 10 mg of a sample at 200° C. under a nitrogen atmosphere;

keeping at 200° C. for 5 minutes;

cooling down to −90° C. at a rate of 10° C./minute; and

heating at a rate of 10° C./minute, thereby obtaining an endothermic curve, Tg being measured from the curve according to JIS K7121.

(4) Melt Flow Rate (MFR, Unit: g/10 Minutes)

It was measured according to the method prescribed in JIS-K-6758 at 230° C. under a load of 2.16 Kg.

### (5) Tensile Strength (Unit: MPa)

It was measured at 23° C. at a tensile speed of 10 mm/minute with a small dumbbell shaped specimen (2 mm-thick) prescribed in JIS No. 1.

### (6) Bending Strength (Unit: MPa)

It was measured at 23° C. at a tensile speed of 50 mm/minute with a 12.7 mm×80 mm shaped specimen (4 mm-thick) with a span of 64 mm.

(7) Izod Impact Strength (Unit: kJ/m²)

It was measured at 23° C. or −30° C. with a V-notched 12.7 mm×65 mm shaped specimen (4 mm-thick).

(8) Volume-Average Particle Diameter (Dv) (Unit: 4 μm) of Dispersed Particles Corresponding to Copolymer Parts, Formed under Molding, Provided that Cross-Section of those Particles has Round Shape

It was measured according to a method comprising the steps of:

cutting out the test specimen molded for measuring tensile strength in the above (5) along its cross-section at −80° C. with a microtome knife;

dyeing at 60° C. for 90 minutes with a ruthenium acid vapor;

cutting at −50° C. with a diamond cutter, thereby making a 800 Å-thick ultrathin slice;

observing the ultrathin slice at 6,000-fold magnification with a transmission electron microscopy, type H-8000, manufactured by Hitachi, Ltd., wherein black color-dyed parts correspond to the copolymer parts (hereinafter, referred to as EP parts);

photographing three different visual fields of the transmission electron microscopy;

image-treating those photographs with a highly accurate image-editing software “A-ZO KUN” manufactured by Asahi Engineering. Co., Ltd., as mentioned below, thereby measuring the volume-average particle diameter (Dv) of dispersed particles corresponding to the EP parts, provided cross-section of those particles has round shape.

### (Image-Treating)

It was carried out according to a method comprising the steps of:

introducing the above photographs into a computer with a scanner GT-9600 manufactured by Epson Corp. (100 dpi, 8 bit);

digitizing with a highly accurate image-editing software “A-ZO KUN” manufactured by Asahi Engineering. Co., Ltd., thereby obtaining an analysis area of 1,116 μm²;

obtaining a diameter of a circle having the same area as that of the EP parts (circle-corresponding particle diameter: Di, unit: μm), because dispersed particles corresponding to the EP parts have an irregular shape; and

calculating the captioned volume-average particle diameter (Dv) according to the following formula,

$$DV = {\sum }_{i = 1}^{n} {Di}^{4} / {\sum }_{i = 1}^{n} {Di}^{3}$$

wherein i is an integer of 1 to n, and Di is a circle-corresponding particle diameter of each particle.

Test specimens of injection molded articles used in Examples 1 to 3 and Comparative Examples 1 to 4 for measuring physical properties in the above (5) to (8) were prepared according to the following method comprising the steps of:

adding, as an antioxidant, 0.05 part by weigh of calcium stearate manufactured by Kyodo Chemical Co., Ltd., 0.2 part by weight of 3,9-bis[2-(3-(3-tert-butyl-4-hydroxy-5-methylphenyl)propyonyloxy)-1,1-dimethylethyl]-2,4,8,10-tetraoxaspiro [5.5]undecane (trade name of SUMILIZER GA80) manufacture by Sumitomo Chemical Co., Ltd., and 0.2 part by weight of bis(2,4-di-tert-butyl-phenyl)pentaerythritoldiphosphite (trade name of ULTRANOX 626) manufacture by GE Specialty Chemicals Inc., to the propylene block copolymer obtained by polymerization;

pelletizing the resultant mixture at 190° C. (preset temperature) at a screw speed of 300 rpm with a twin screw extruder (trade name of KZW15-45MG, inner diameter=15 mm and L/D=45) manufactured by Technovel Corporation; and

injection molding the above pellets at 220° C. with an injection molding machine (type Si-30III) manufactured by Toyo Machinery & Metal Co., Ltd. keeping mold cooling-temperature at 50° C., thereby obtaining test specimens of injection-molded articles.

The catalyst components (A) and (B) used for producing polymers utilized in Examples and Comparative Examples were synthesized as follows:

dichloro{1,1′-dimethylsilylenebis[2-ethyl-4-(2-fluoro-4-biphenyl)-4H-azulenyl]}hafnium was used as the catalyst component (A), which was synthesized according to a method disclosed in JP 2000-95791A, Example 9; and

the catalyst component (B) was synthesized according to a method disclosed in JP 2003-171412A, Example 1(2).

### Example 1

### (1) Step 1: Production of Propylene Polymer (P)

Under an argon atmosphere, 7.7 mg of the catalyst component (A) and 1 mL of a toluene solution (concentration: 1 mmol/mL) of triisobutylaluminum were added to 40 ml of toluene. There was suspended 161.1 mg of the catalyst component (B) in the above toluene solution, thereby preparing a toluene slurry of the polymerization catalyst components.

A stainless steel autoclave having a 3 liter inner-volume and equipped with a stirrer was dried under a reduced pressure, and was purged with an argon gas. The autoclave was cooled, and then was evacuated. The above toluene slurry of the catalyst components was introduced into the autoclave. Next, 0.020 MPa of hydrogen and 780 g of propylene were added thereto. The autoclave was adjusted to 20° C. in its inner temperature, and was stirred for 5 minutes. Then, the autoclave was heated up to 65° C., and was stirred for 30 minutes, thereby polymerizing in the step 1.

### (2) Step 2: Production of Propylene Copolymer (EP1)

After completion of the above step 1, the unreacted monomer was purged. The autoclave was purged with an argon gas, and a small amount of the produced polymer was sampled. Next, the autoclave was depressurized, and then 60 g of propylene and 80 g of ethylene were added thereto. The autoclave was heated up to 80° C. in its inner temperature, and was stirred for 5 minutes, thereby polymerizing in the step 2.

### (3) Step 3: Production of Ethylene Copolymer (EP2)

After completion of the above step 2, the unreacted monomer was purged. The autoclave was purged with an argon gas, and a small amount of the produced polymer was sampled. Next, the autoclave was depressurized, and then 44 g of propylene and 97 g of ethylene were added thereto. The autoclave was heated up to 90° C. in its inner temperature, and was stirred for 5 hours, thereby polymerizing in the step 3. After completion of the step 3, the unreacted monomer was purged to terminate the polymerization. The produced polymer was dried under a reduced pressure at 60° C. for 5 hours, thereby obtaining 286.4 g of a powdery polymer.

The above polymerization operations (1) to (3) were repeated two times, and the obtained polymer was used for the above pelletizing, and for preparing the above injection molded articles.

### Example 2

Example 1 was repeated except that 9.6 mg of the catalyst component (A), 163.7 mg of the catalyst component (B), and 0.015 MPa of hydrogen were used in Example 1(1), respectively, thereby obtaining 324.1 g of a powdery propylene block copolymer.

The above polymerization operations (1) to (3) were repeated two times, and the obtained polymer was used for the above pelletizing, and for preparing the above injection molded articles.

### Example 3

Example 1 was repeated except that 5.6 mg of the catalyst component (A), 149.2 mg of the catalyst component (B), and 0.015 MPa of hydrogen were used in Example 1(1), respectively, the polymerization was carried out at 65° C. for 15 minutes in Example 1(2), and the polymerization was carried out at 80° C. with 48 g of propylene and 93 g of ethylene in Example 1(3), thereby obtaining 224.0 g of a powdery propylene block copolymer.

The above polymerization operations (1) to (3) were repeated two times, and the obtained polymer was used for the above pelletizing, and for preparing the above injection molded articles.

### Comparative Example 1

Example 1 was repeated except that 7.8 mg of the catalyst component (A) and 161.9 mg of the catalyst component (B) were used in Example 1(1), respectively, the polymerization was carried out at 65° C. for 5.5 hours with 65 g of propylene and 125 g of ethylene in Example 1 (2), and the step (3) was omitted, thereby obtaining 345.1 g of a powdery propylene block copolymer.

The above polymerization operations (1) to (3) were repeated two times, and the obtained polymer was used for the above pelletizing, and for preparing the above injection molded articles.

### Comparative Example 2

Example 1 was repeated except that 6.8 mg of the catalyst component (A) and 156.7 mg of the catalyst component (B) were used in Example 1(1), respectively, the polymerization was carried out at 65° C. in Example 1(2), and the polymerization was carried out at 80° C. with 30 g of propylene and 110 g of ethylene in Example 1(3), thereby obtaining 307.3 g of a powdery propylene block copolymer.

The above polymerization operations (1) to (3) were repeated two times, and the obtained polymer was used for the above pelletizing, and for preparing the above injection molded articles.

### Comparative Example 3

Example 1 was repeated except that 9.1 mg of the catalyst component (A), 154.1 mg of the catalyst component (B) and 0.015 MPa of hydrogen were used in Example 1(1), respectively, the polymerization was carried out for 5.5 hours with 65 g of propylene and 125 g of ethylene in Example 1(2), and the step (3) was omitted, thereby obtaining 295.3 g of a powdery propylene block copolymer.

The above polymerization operations (1) to (3) were repeated two times, and the obtained polymer was used for the above pelletizing, and for preparing the above injection molded articles.

### Comparative Example 4

Example 1 was repeated except that 8.9 mg of the catalyst component (A), 160.9 mg of the catalyst component (B) and 0.015 MPa of hydrogen were used in Example 1(1), respectively, and the polymerization was carried out with 70 g of propylene and 70 g of ethylene in Example 1(2), thereby obtaining 322.9 g of a powdery propylene block copolymer.

The above polymerization operations (1) to (3) were repeated two times, and the obtained polymer was used for the above pelletizing, and for preparing the above injection molded articles.

The propylene block copolymers obtained in Examples 1 to 3 and Comparative Examples 1 to 4 are shown in Tables 1 and 2 in their structural analytical values, glass transition temperature (Tg) of their pellets, and the particle diameter and property measurement results of the copolymer parts in their injection molded articles.

TABLE 1

| | | | Example | | | Comparative Example | | | |
|---|---|---|---|---|---|---|---|---|---|
| | | | 1 | 2 | 3 | 1 | 2 | 3 | 4 |
| P | [η]_{P} | [dl/g] | 1.14 | 1.55 | 1.71 | 1.07 | 1.14 | 1.23 | 1.34 |
| EP1 | X_{EP1} | [wt | 5.6 | 7.1 | 7.4 | 18.9 | 6.0 | 24.3 | 9.2 |
| | | %] | | | | | | | |
| | [η]_{EP1} | [dl/g] | 5.54 | 4.84 | 6.62 | 5.82 | 5.48 | 5.11 | 4.26 |
| | C₂′ | [mol | 45.8 | 45.2 | 48.8 | 57.4 | 41.8 | 49.5 | 31.3 |
| | | %] | | | | | | | |
| EP2 | X_{EP2} | [wt | 10.2 | 9.7 | 7.8 | — | 8.9 | — | 9.8 |
| | | %] | | | | | | | |
| | [η]_{EP2} | [dl/g] | 4.15 | 4.35 | 5.22 | — | 6.35 | — | 3.96 |
| | C₂′ | [mol | 57.9 | 62.5 | 55.4 | — | 82.4 | — | 64.4 |
| | | %] | | | | | | | |

TABLE 2

| | | Example | | | Comparative Example | | | |
|---|---|---|---|---|---|---|---|---|
| | | 1 | 2 | 3 | 1 | 2 | 3 | 4 |
| Tg | [° C.] | −58.1 | −58.0 | −57.8 | −57.7 | −53.6 | −56.9 | −54.5 |
| Dv | [μm] | 0.76 | 0.76 | 0.76 | 1.09 | 0.79 | 1.61 | 0.82 |
| MFR | [g/10 min.] | 19.2 | 5.7 | 3.3 | 19.5 | 17.3 | 8.7 | 8.6 |
| Tensile strength | [MPa] | 26.5 | 27.3 | 27.5 | 24.3 | 26.4 | 23.5 | 25.5 |
| Bending strength | [MPa] | 1,075 | 988 | 956 | 982 | 1,025 | 893 | 922 |
| Izod impact strength | | | | | | | | |
| (23° C.) | [kJ/m²] | 8.4 | 16.5 | 16.3 | 8.1 | 8.0 | 12.2 | 14.9 |
| (−30° C.) | [kJ/m²] | 3.7 | 5.2 | 5.1 | 3.9 | 3.4 | 4.9 | 4.4 |

### INDUSTRIAL APPLICABILITY

The polypropylene block copolymer of the present invention can be molded to obtain molded articles excellent in their stiffness and impact resistance, and particularly low temperature impact resistance.

1. A propylene block copolymer satisfying the following requirements (I) to (VI), which is obtained according to a process comprising the first step of producing a propylene polymer component (1), the second step of producing a propylene copolymer component (2) in the presence of the component (1), and the third step of producing an ethylene copolymer component (3) in the presence of the components (1) and (2);
(I) the propylene polymer component (1) has a melting temperature of 155° C. or higher measured according to DSC;
(II) the propylene copolymer component (2) contains ethylene in an amount of 40 to 50% by mol measured according to a ¹³C-NMR spectrum, and has an intrinsic viscosity of 2.0 to 8.0 dl/g measured at 135° C. in TETRALINE;
(III) the ethylene copolymer component (3) contains ethylene in an amount of 45 to 70% by mol measured according to a ¹³C-NMR spectrum, and has an intrinsic viscosity of 3.0 to 8.0 dl/g measured at 135° C. in TETRALINE, provided that said ethylene content is larger than the ethylene content in the propylene copolymer component (2);
(IV) a ratio by weight of the propylene copolymer component (2) to the ethylene copolymer component (3) is 1/10 to 1/1;
(V) the propylene block copolymer has a glass transition temperature of −55.0° C. or lower measured according to DSC; and
(VI) dispersed particles comprising the components (2) and (3) have a volume-average particle diameter of 1.0 μm or less, measured by observing a central part of a cross-section of an article prepared by injection-molding the above propylene block copolymer, provided that the above particles have a round shape in their cross-section.

2. The propylene block copolymer according to claim 1, wherein the propylene block copolymer is produced with a catalyst system containing as an essential component a combination of (A) a cyclopentadienyl ring-containing transition metal compound of the groups 4 to 6 of the periodic table, (B) modified particles obtained by contacting the following (a), (b) and (c) and (d) particles with one another, and (C) an organoaluminum compound:
(a): a compound represented by the following general formula [4],
M¹L¹ₘ [4],
(b): a compound represented by the following general formula [5],
R¹ₜ₋₁TH [5], and
(c): a compound represented by the following general formula [6],
R²ₜ₋₂TH₂ [6]
wherein M¹ is a typical metal atom of the group 1, 2, 12, 14 or 15 of the periodic table; m is the valence of M¹; L¹ is a hydrogen atom, a halogen atom or a hydrocarbon group, and when plurality of L¹ exist, they are the same as or different from one another; R¹ is an electron-withdrawing group or an electron-withdrawing group-containing group, and when plurality of R¹ exist, they are the same as or different from one another; R² is a hydrocarbon group or a halogenated hydrocarbon group; T is independently of each other an atom of the group 15 or 16 of the periodic table; and t is the valence of T in respective compounds.
